(19) United States
(12) Patent Application Publication
(10) Pub. No.: US 2022/0147693 A1
(43) Pub. Date: May 12, 2022

(54) Systems and Methods for Generating Documents from Video Content

(71) Applicant: Vizetto Inc., Mississauga (CA)

(72) Inventor: Avanindra Utukuri, Mississauga (CA)

(21) Appl. No.: 17/431,171

(22) PCT Filed: Feb. 18, 2020
(86) PCT No.: PCT/CA2020/050209

§ 371 Date: Aug. 15, 2021

Related U.S. Application Data
(60) Provisional application No. 62/806,816, filed on Feb. 17, 2019.

(51) Int. Cl. G06F 40/106; G06V 20/40; G06F 40/166

(52) U.S. Cl. CPC G06F 40/106; G06V 20/46; G06F 40/166; G06V 20/41

(57) ABSTRACT

Various systems and methods for generating a document containing content displayed in a video image are disclosed. In some embodiments, a series of selection regions is defined. Each of the selection regions is extracted from the video display. A document is generated containing the selection regions. The document may be a multi-page document and may be created in an image, PDF or other selected document format.

### FIELD

The described embodiments relate to systems and methods for document generation from content shown on a video display.

### SUMMARY

Exemplary embodiments described herein provide details relating to systems and methods for methods for extracting video content from a video display and generating a single page or multi-page document.

A user may define content to be extracted from a video display. The specified content is extracted and provided to the user as a single or multiple page document.

To generate a document containing multiple elements of extracted video content, a document generation function is executed on a computer. A user defines a series of selection regions of video content, and the document generation function records each successive selection region. Successive selection regions may be defined while the video content remains static or after the video content has changed. For example, the video content may be changed by the user or by other software operating on the computer. Video content corresponding to each selection region is extracted and recorded. A document having one or more pages is generated including each element of extracted video content. In some instances, each element of extracted video content may be included one a separate a page of a multi-page document. The document may be generated in any suitable format, such as an image format, portable document format (PDF) or any other format.

Some embodiments provide a method of generating a document from a video display, the method comprising: recording a series of selection regions wherein each selection region identifies a portion of the video display; extracting elements of video content from the video display, wherein each element of video content corresponds to a selection region; and generating a document containing the extracted elements of video content.

In some embodiments, the document is generated in an image format.

In some embodiments, the document is generated in a portable document format (PDF).

In some embodiments, the document is generated in a selected format.

In some embodiments, the document is generated in a multi-page document format.

In some embodiments, the document is generated with multiple pages, wherein each page includes one element of extracted video content.

In some embodiments, the document is generated with multiple pages, wherein at least one page include extracted video content scaled to fit at least one dimension of the page.

In some embodiments, the document has one or more pages, and wherein at least one page includes at least two elements of extracted video content.

The embodiments described herein are exemplary only and other implementations and configurations are also possible.

### DESCRIPTION OF THE DRAWINGS

In the drawings:

FIG. 1a illustrates a document generation system;

FIG. 1b illustrates a document generation options window;

FIG. 2 illustrates a method of generating a document from a video display.

FIGS. 3a-c illustrates various selection regions and corresponding extracted video content and documents;

FIG. 4 illustrates a document generated according to the method of FIG. 2;

FIG. 5 illustrates a method generating a document containing multiple elements of extracted video content;

FIG. 6 illustrates multiple selection regions on a video display; and

FIG. 7 illustrates a multiple page document corresponding to the selection regions of FIG. 6.

The Figures are merely illustrative of the embodiments shown and described below. They are not limiting and are not drawn to scale.

### DESCRIPTION OF EXAMPLE EMBODIMENTS

Numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

Terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

Terms such as “connected” and “coupled” mean that a first element is able to communicate or otherwise interact with another device, either through a direct connection or through intermediary devices. The connection or coupling may be physical, as with a connecter plugged into a corresponding hardware port, or virtual as with a software object that transmits data to another object. A connection or coupling be achieved using a physical cable or through a wireless network or communication means.

The wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication. In still other embodiments, there may be a combination of communication interfaces implemented as hardware, software, and any combination thereof.

Program code may be applied to input information and data to perform the functions described herein and to generate output information. The output information is applied to one or more output devices, in known fashion.

A program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact discs, tapes, chips, wireline transmissions, satellite transmissions, internet transmission or downloads, magnetic and electronic storage media, digital and analog signals, and the like. The computer useable instructions may also be in various forms, including compiled and non-compiled code.

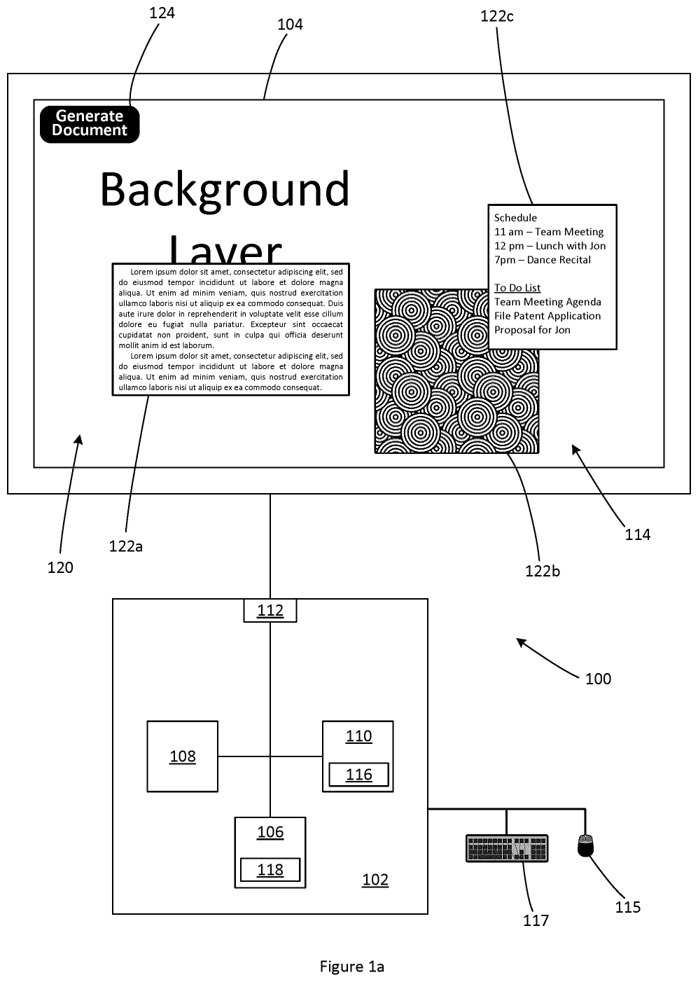

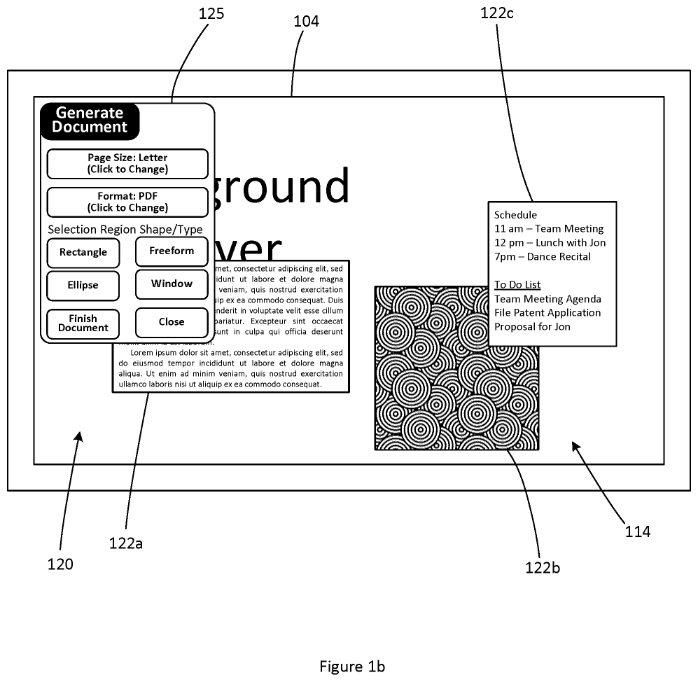

Reference is made to FIG. 1, which illustrates a document generation system 100 that includes a computer 102 and a display screen 104. Computer 102 may be a general purpose computer that can be configured to perform various tasks and provide various functions under the control of an operating system and various software programs, in typical manner.

Computer 102 includes a central processor 106, a main memory 108 and graphics module 110. Graphics module 110 may be a software program that executes on processor 106 or may be a hardware system that is coupled to processor 106. Graphics module generates a video display signal an output port 112. The video display signal is transmitted to the display screen 104 via a video cable 113. A video display 114 corresponding to the video display signal is shown on display screen 104. Graphics module 110 generates the video display in a graphics memory 116, which may within the main memory 108, and shared with the processor 106, or it may be a separate memory that is dedicated to the graphics module, as in this example embodiment.

Video display 114 is generated in accordance with an operating system that controls the operation and usage of computer 102. In this example embodiment, video display 114 has background layer 120 and may one have one or more windows that display content under the control or the operating system or other software programs operating on the computer 102, or both. In the example shown in FIG. 1a, the video display 114 includes a background layer 120, and three windows 122 that include content generated by one or more software programs.

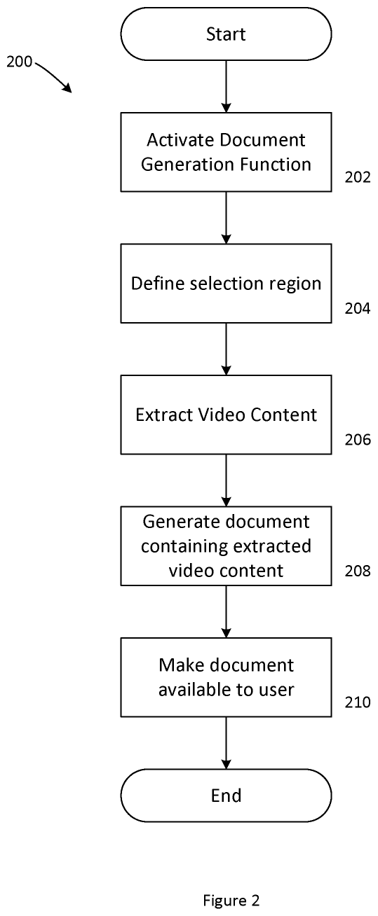

Referring additionally to FIG. 2, a user may generate a document based on the video content displayed in video display 114 in accordance with method 200.

A document generation software program 118 is executed on computer 102. The document generation program displays a document generation icon 124 in video display 114. Document generation icon 124 may be displayed anywhere on the video display 114.

Method 200 begins in step 202 with the user activating a document generation function. A user of computer 102 may activate the document generation function by clicking on or otherwise interacting with the document generation icon 124 in the video display 114 on display screen 104. The user may click on the document generation icon 114 using a mouse 115 or other human interface device (HID) coupled to computer 102. In various embodiments, the user may activate the document generation function using any suitable capability of the system 110. For example, if the display screen 104 has touchscreen functionality, a user may activate the document generation function by using a keyboard 117, touching the document generation icon 124 on a touchscreen, or by making a particular gesture. In other embodiments, the user may activate the document generation function in any manner that is available on computer 102.

When the document generation function is activated, the document generation program 118 displays various document generation options in a document generation options window 125 as shown in FIG. 1b. A user may select the options by interacting with the respective buttons in the document generation options window 125.

In this example, the document generation options include:
A button to select a size or shape for the document that will be generated. The document may be generated with a selected page size or aspect ratio. For example, a document may be generated with a 16×9 aspect ratio. As another example, a document may be generated to fit on letter size paper, A4 paper, legal size paper, etc. A document may be formatted with other attributes, such as margins of a selected size.
A button to select a format for the document to be generated. The document may be generated in any format suitable for depicting video or graphic content. For example, the document may be an image document in a graphics format such as JPEG, GIF, bitmap, etc, a general document format such as portable document format (PDF) or another document format.
Several buttons to select a shape or type of selection region.

Method 200 next proceeds to step 204, in which the user defines a selection region on the video display 114 under the control of the document generation function. The selection region defines a portion of the video content on the video display that will be included in the document. A user may be able to define a selection region covering the entire video display, so that the entire video content of the video display will be in the document. The user first selects the shape or type of selection region to be defined in the document generation options window 125. In this example, a selection region may be defined as a rectangle, as a freeform or irregular shape or as an ellipse. In addition, an entire window may be defined as a selection region. In various embodiments, different shapes or types of selection regions may be permitted.

The document generation function may allow a user to define the selection region in various ways, again depending on the capability of computer 102. For example, a user may be able to define a selection region using a mouse, keyboard, touchscreen or other human interface device.

Typically, when a shape or type of selection region has been selected, the document generation options window 125 will be closed to allow the user to see more of the video content on the video display 114. In some embodiments, the document generation icon 124 may be also be hidden or made translucent to allow video content under the document generation icon to be seen.

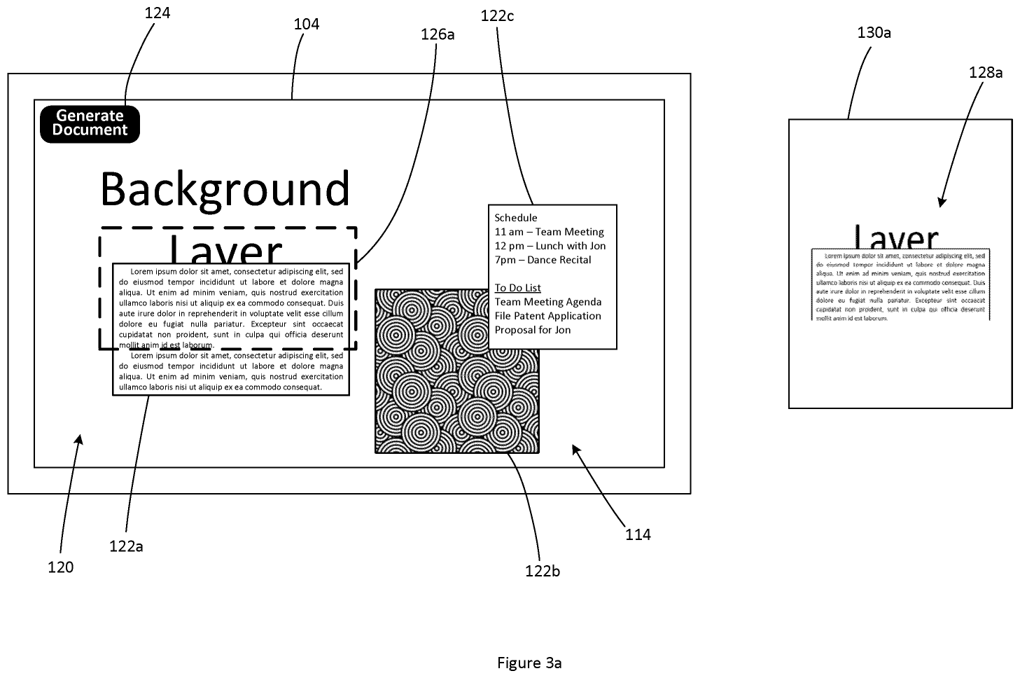

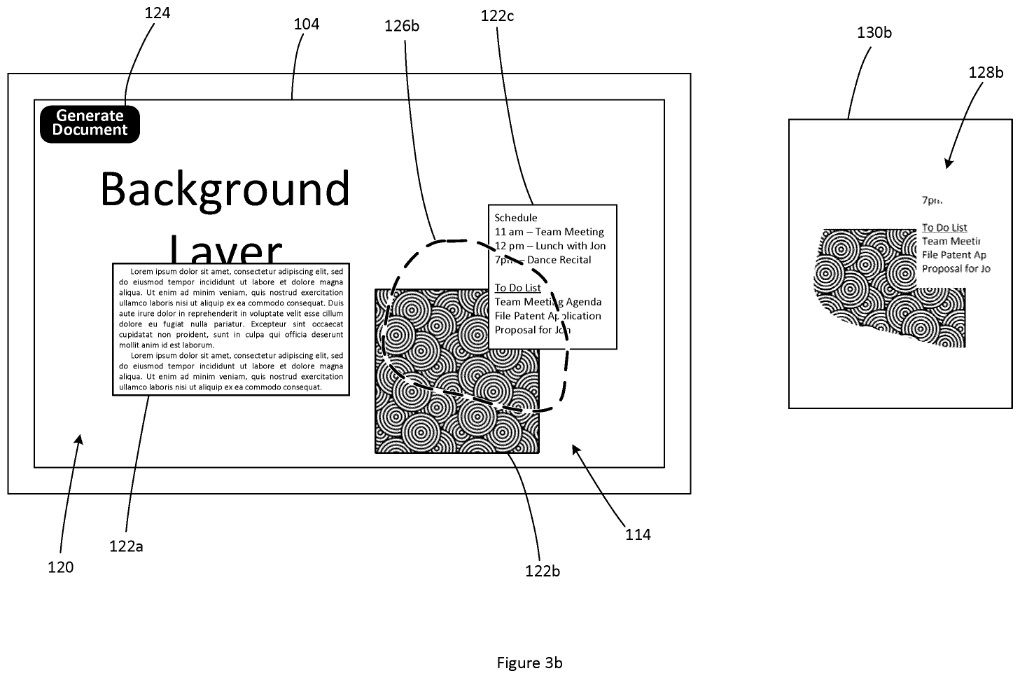

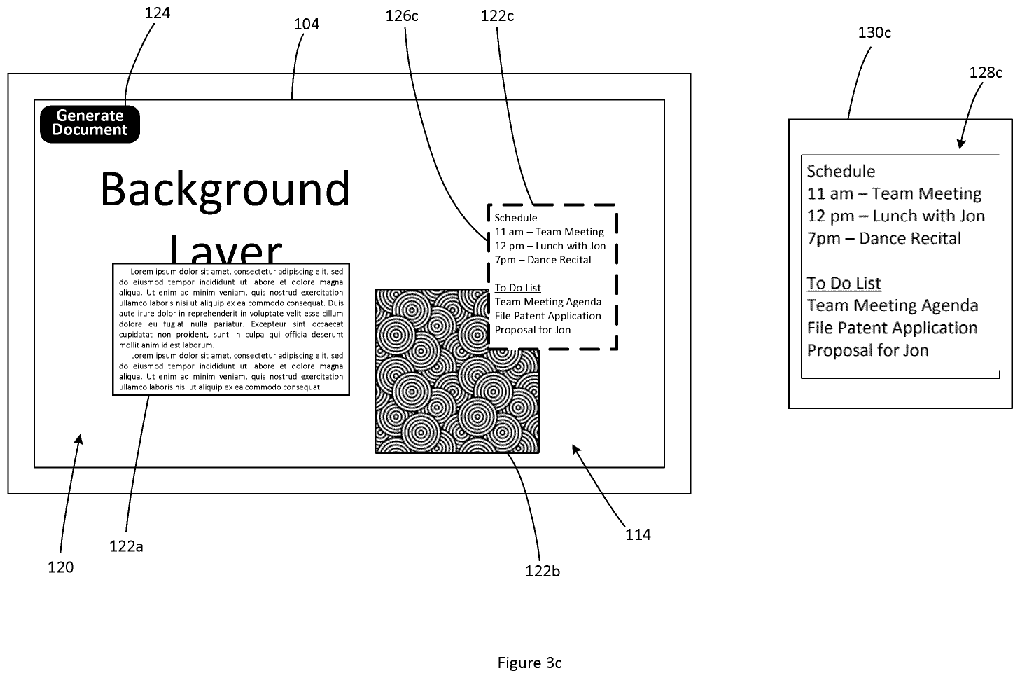

FIG. 3a illustrates a rectangular selection region 126a that may be defined by identifying opposing corners of the selection region. FIG. 3b illustrates a freeform or irregular selection region 126b that may be defined by drawing the shape of the selection region using a mouse, stylus or finger, for example. FIG. 3c illustrates a selection region 126c that corresponds to window 122a.

The document generation function records the defined selection region.

Method 200 next proceeds to step 206 in which the document generation program 118 extracts video content within the selection region from the video display 114. FIGS. 3a-3c illustrate extracted video content 128 corresponding to the respective selection regions 126 in those figures. Document generation program 118 may extract the selected video content by making a copy of video content within the selection region.

Method 200 next proceeds to step 208, in which the document generation program 118 generates a document containing the extracted video content 128.

FIGS. 3a-3c illustrate documents 130 containing extracted video content 128 corresponding to the respective selection regions 126 in those figures. In this example, the extracted video content has been sized to fit on a sheet of letter sized (8.5″×11″) paper.

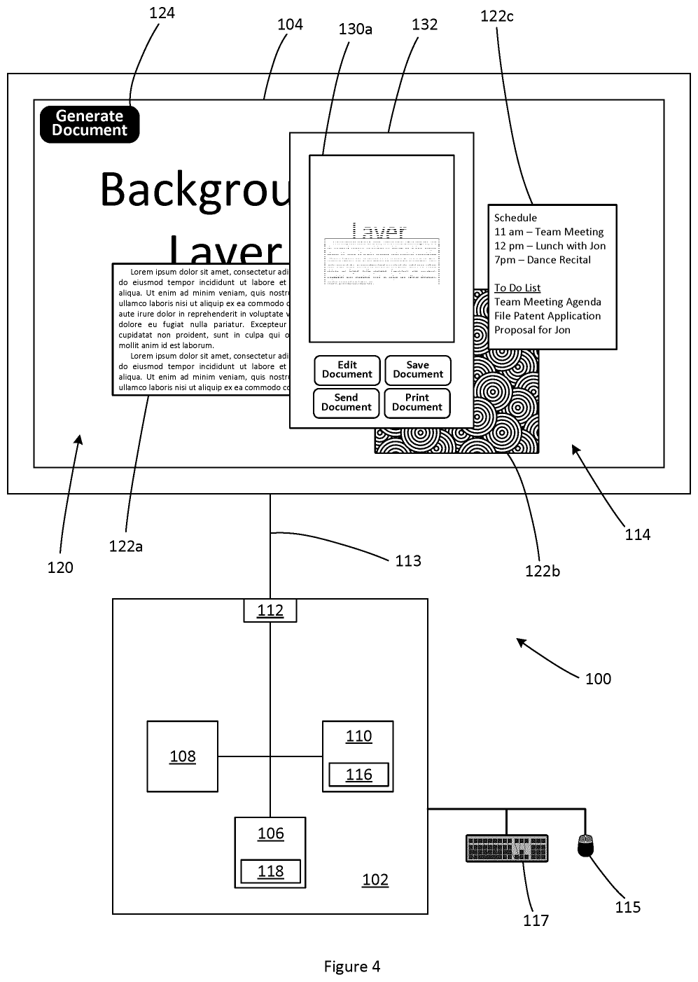

Method 200 next proceeds to step 210, in which the generated document is made available to the user. Referring to FIG. 4, an example generated document 130a is displayed on the display screen 104 in a document window 132. The document generation program 118 may provide the user with various options. For example, the user may have options to edit the generated document 130, save the generated document 130 in the file system of the computer 102, to send the generated document in an e-mail or another message type, to print the generated document or to otherwise use the generated document.

Method 200 then ends.

Method 200 allows a user to select a portion of a video display 114 and to generate a document containing video content in the selected portion.

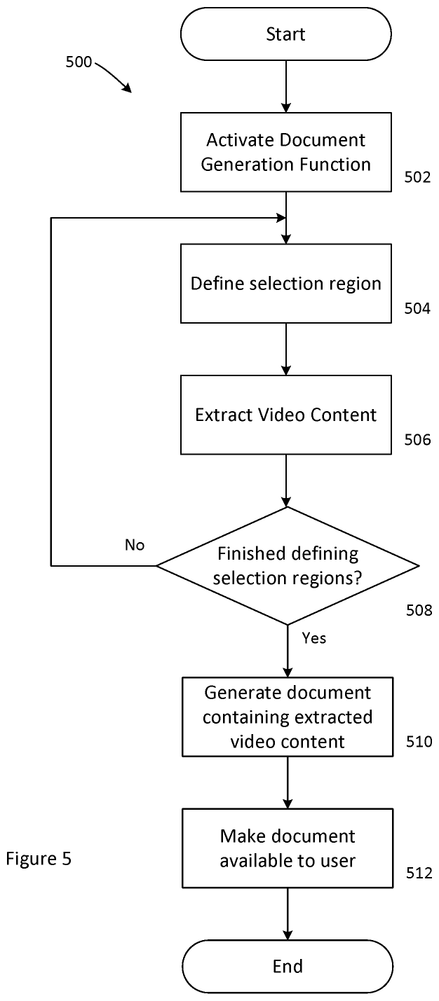

Reference is next made to FIG. 5, which illustrates a method for generating a document containing multiple element of extracted video content.

Method 500 begins in step 502 in which a user activates a document generation function, as described above in relation to step 202. When the user activates the document generation function, a document generation options window 125 is illustrated as shown in FIG. 1b, allowing page size and format options to be selected, and the shape or type of selection region to be selected.

Method 500 next proceeds to step 504, in which the document generation function allows a user to specify selection region, as in step 204. The user may first select the shape or type of selection region using the buttons in the document generation options window 125. Once the shape or type of the selection region has been chosen, the document generation options window 125 may be hidden or made translucent. The document generation function then allow the user to define the selection region.

Method 500 next proceeds to step 506, in which the document generation function extracts video content from the selection region, as in step 206. The extracted video content is recorded by the document generation function. Steps 504-508 may be repeated multiple times during a particular instance of method 500. During each repetition of step 504, the user may select options for the document, or the next page in the document, and may select a shape or type of selection region. During the first, second and each subsequent repetition of step 506 (if any), the extracted video content is recorded as the first, second and subsequent (if any) element of extracted video content.

Method 500 next proceeds to step 508, in which the document generation function displays the document generation options window 125 is displayed, allowing a user to indicate the user has finished identifying selection regions for inclusion in the document. The user may indicate that the user is finished doing so by clicking a “Finish Document” button. If the user indicates that the document should be generated, method 500 proceeds to step 510. Otherwise, the user may indicate that additional video content is to extracted by selecting a shape or type for the next selection region; or by simply beginning the process of defining the next selection region. If additional video content is to be extracted, method 500 returns to step 504.

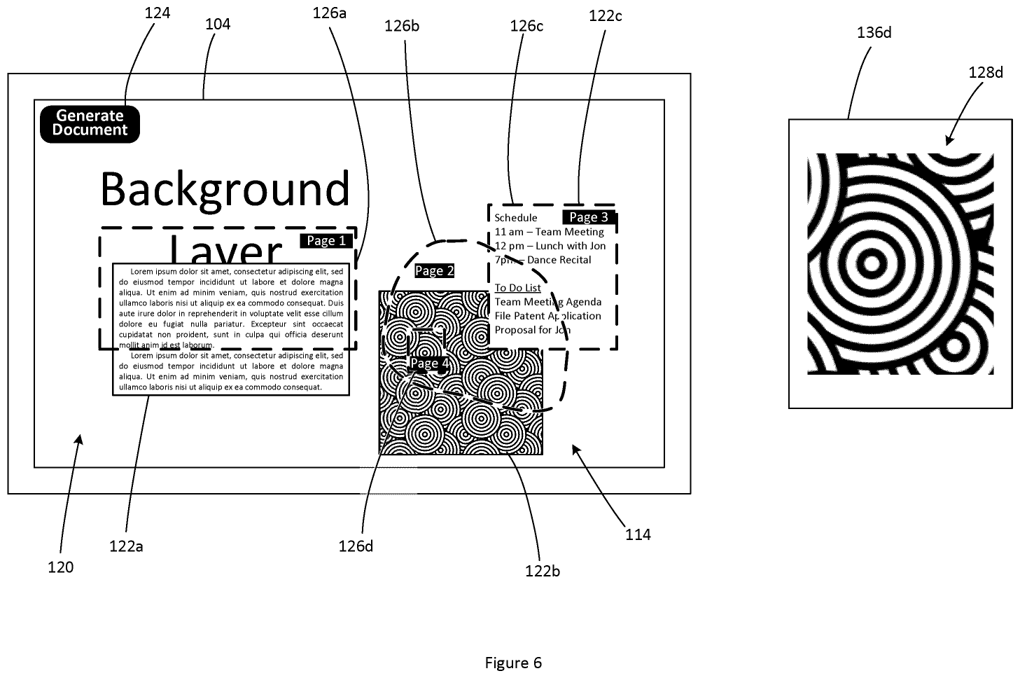

As an example, a user may sequentially define four selection regions, as shown in FIG. 6, Selection regions 126a-c correspond to those shown in FIGS. 3a-c. In addition, selection region 126d is defined, and FIG. 6 illustrates the corresponding extracted video content 128d, and document page 130d containing the extracted video content scaled to fit the page. Optionally, as shown in FIG. 6, as each selection region is defined, the corresponding selection region remains displayed on the display screen and the page number corresponding to each selection region is displayed allowing a user to see the previously defined selected regions and the order of the pages that will be generated.

In step 510, a document 130 is generated from the extracted video content recorded by the document generation function in the successive repetitions of step 506. In some embodiments, a series of documents, each containing one of the elements of extracted video content may be generated, as described above in relation to step 208. In other embodiments, a single document may be generated containing a series of pages, each page containing one of the elements of extracted video content.

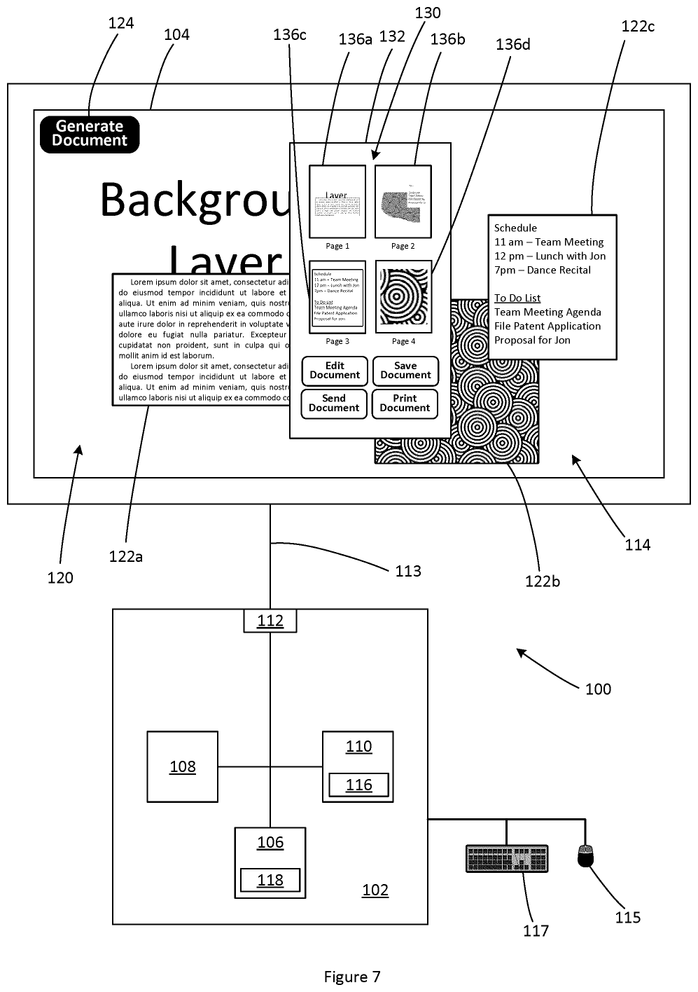

Method 500 then proceeds to step 512, in which the one or more documents 130 are generated in step 510 are made available to the user, as described above in step 210. Referring to FIG. 7, a four page document 130 containing pages 136a-d is displayed in a document window 132, and the user may edit, save, send or print the document. In other embodiments, additional options may be provided. Document pages 136a-c correspond to document 130a-c shown in FIGS. 3a-c.

The document generation function 118 allows overlapping selection regions to be defined, as illustrated by selection regions 126b and 126c, and corresponding pages 2 and 3 of the document 130 which contain overlapping text from window 122c. In this example, the extracted content on each page is scaled to fit the page. Page 4, corresponding to selection region 126d is smaller than, and within, selection region 126b. As a result, the extracted video content 128d on page 4 is scaled to a larger magnification or zoom that the corresponding content on page 2. A user may generate a document with overlapping selection regions to allow different amounts of detail in the video content to be observed on different pages in the document.

Method 500 allow a user to extract multiple elements of video content in a series of documents or as a series of pages in a single document. Successive elements of video content may be selected from a static video display, allowing different parts (or overlapping parts) of the video display to be captured as a series of elements of extracted video content. The video display may change between repetitions of step 506, allowing video content from a changing video display to be captured over time. For example, the video display may change because a video is played on all or part of the video display, because the user moves windows or content on the video display or because software operating on the computer makes changes in the video display.

Steps 504-508 of method 500 are repeated allowing multiple selection regions to be defined. In various embodiments, in step 506, the document generation function may simply record each selection region as it is defined, and then extract video content corresponding to each selection region after the method proceed to step 510.

In the example document illustrated in FIG. 7, each element of extracted video content 126 is on a separate page 130 of the document 136. In other embodiments, two or more elements of extracted video content may be included on a single page of a document, depending on formatting options for the document. For example, the document generation function may provide options to fit extracted video content on parts of a page. For example, each page may have two or more portions into which two or more corresponding elements of extracted video content may be fitted. A document generation program may be configured to automatically scale extracted to fit the width or height of a page 136 in document 130, and to include multiple elements of extracted video content on a single page in a document if possible.

In some embodiments, a document generation function may be configured or configurable by the selection of appropriate options to include all extracted video content in a single page document. The document may be generated in any image or document format.

Various inputs from the user have been described with references to specific types of input devices. For example, some inputs may be described as clicks, which typically refers to the use of a mouse coupled to a computer to move a cursor onto a control element such as a button or input field and pressing a mouse button, or by pressing on a touchscreen with a finger or stylus. In various embodiments, a user may provide inputs using any appropriate means. For example, a user may make a touch or other gesture, use a keyboard or use any other functionality available at the computer.

The document generation functions may be implemented on a computer in various ways. In some embodiments, the document generation function may be standalone software that may be instantiated by a user to extract video content displayed by other software programs or by the operating system of a computer. In other embodiments, the document generation function may be provided as part of the operating system of a computer. In other embodiments, the document generation function may be provided as a component of a software program, for example a drawing or image editing program, a meeting or presentation program or an electronic whiteboard program. In embodiments where the document generation program is provided as a component of a software program, the document generation function may be able to extract video content from the entire video display of the computer, or it may be configured to be able to extract only video content generated by the software program. In some embodiments, the video content that may be extracted by the document generation function may be configured by an administrator or by the user or both.

Various example embodiments of the present invention have been described here by way of example only. Various modification and variations may be made to these exemplary embodiments without departing from the spirit and scope of the invention.

1. A method of generating a document from a video display, the method comprising:
recording a series of selection regions wherein each selection region identifies a portion of the video display;
extracting elements of video content from the video display, wherein each element of video content corresponds to a selection region; and
generating a document containing the extracted elements of video content.

2. The method of claim 1 wherein the document is generated in an image format.

3. The method of claim 1 wherein the document is generated in a portable document format (PDF).

4. The method of claim 1 wherein the document is generated in a selected format.

5. The method of claim 1 wherein the document is generated in a multi-page document format.

6. The method of claim 1 wherein the document is generated with multiple pages, wherein each page includes one element of extracted video content.

7. The method of claim 1 wherein the document is generated with multiple pages, wherein at least one page includes extracted video content scaled to fit at least one dimension of the page.

8. The method of claim 1 wherein the document has one or more pages, and wherein at least one page includes at least two elements of extracted video content.
